(19) United States
(12) Patent Application Publication
(10) Pub. No.: US 2016/0359971 A1
(43) Pub. Date: Dec. 8, 2016

(54) METHOD AND SYSTEM FOR TRACKING INFORMATION TRANSFER BETWEEN DEVICES

(71) Applicant: VIJAY KARTHIK UDAYAKUMAR, TAMIL NADU (IN)

(72) Inventor: VIJAY KARTHIK UDAYAKUMAR, TAMIL NADU (IN)

(21) Appl. No.: 15/174,974

(22) Filed: Jun. 6, 2016

(30) Foreign Application Priority Data
Jun. 5, 2015 (IN) 2829/CHE/2015

(51) Int. Cl. H04L 29/08; H04L 29/06

(52) U.S. Cl. CPC H04L 67/1095; H04L 67/22; H04L 63/0428

(57) ABSTRACT

The present invention relates to a method and system for tracking information transfer between devices. The method includes receiving, by an information logger system, information from a source device. The information is routed from the source device to a destination device through the information logger system. The information includes control information and meaningful information. An information type of the information is detected by the information logger system. The meaningful information is captured from the information based on the information type. The meaningful information is further stored in a predetermined format. Moreover, the information is forwarded to the destination device. The information logger system includes a receiving module, a detecting module, a controlling module, a memory, and a forwarding module.

### CROSS-REFERENCE TO RELATED APPLICATIONS

This non-provisional application claims priority to Indian Provisional Patent Application No. 2829/CHE/2015, tiled on Jun. 5, 2015, which is incorporated herein by reference in its entirety.

### FIELD OF THE INVENTION

The present invention generally relates to information management and more particularly to a method and system for tracking information transfer between devices.

### BACKGROUND TO THE INVENTION

Today, individuals and businesses seek several ways to track and protect information. The information can include personal, sensitive or confidential information in form of but not limited to, text files, email messages, instant messaging communications, multimedia contents, audio and videos files, and database files.

As electronic exchange of the information is rapidly growing, handling and monitoring of the information becomes necessary to prevent information theft and leakage. At present, information handling systems are provided with functionality of transmitting or exchanging information from one device to another in a secured manner by using several available security methods and algorithms. Existing information handling systems are also capable of taking a regular back-up of the information stored in a device. Such regular back-up methods help in recovery of the information in case of damage to original information. Further, certain methods currently exist that prevent exchange or copying of the information. For instance, a restrictive access can be provided by a user or author of the information. Such restrictive access restricts the information from being used, exchanged, or transferred from one device to another. The existing information handling systems include methods to grant right to access the information only to individual persons, to provide restrictive access in terms of allowing only viewing of the information and providing restrictions in terms of modifying the information or in terms of copying of the information. However, the existing information handling systems only enable transfer of the information between devices and are unable to monitor the information and details of the information being transferred.

### SUMMARY OF THE INVENTION:

This summary is provided to introduce a selection of concepts in a simplified format that are further described in the detailed description of the invention. This summary is not intended to identify key or essential inventive concepts of the subject matter, nor is it intended for determining the scope of the invention.

An example of a method of tracking information transfer between devices includes receiving, by an information logger system, information from a source device. The information is routed from the source device to a destination device through the information logger system. The information includes control information and meaningful information. The method includes detecting, by the information logger system, an information type of the information. The method further includes capturing, by the information logger system, the meaningful information from the information based on the information type. The method includes storing, by the information logger system, the meaningful information in a predetermined format. Moreover, the method includes forwarding, by the information logger system, the information to the destination device.

An example of an information logger system for tracking information transfer between devices includes a receiving module configured to receive information from a source device, the information being routed from the source device to a destination device through the information logger system, the information comprising control information and meaningful information. The information logger system also includes a detecting module configured to detect an information type of the information. The information logger system includes a controlling module configured to capture the meaningful information from the information based on the information type. The information logger system includes a memory configured to store the meaningful information in a predetermined format. Moreover, the information logger system includes a forwarding module configured to forward the information to the destination device.

To further clarify advantages and features of the present invention, a more particular description of the invention will be rendered by reference to specific embodiments thereof, which is illustrated in the appended figures. It is to be appreciated that these figures depict only typical embodiments of the invention and are therefore not to be considered limiting of its scope. The invention will be described and explained with additional specificity and detail with the accompanying figures.

### BRIEF DESCRIPTION OF THE FIGURES

The invention will be described and explained with additional specificity and detail with the accompanying figures in which:

FIG. 1 illustrates a block diagram of an environment, in accordance with an embodiment;

FIG. 2 is a block diagram representation of an information logger system, in accordance with an embodiment;

FIG. 3 illustrates an example flow diagram of a method for tracking information transfer between devices, in accordance with an embodiment; and

FIG. 4 illustrates a block diagram of an electronic device, in accordance with one embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

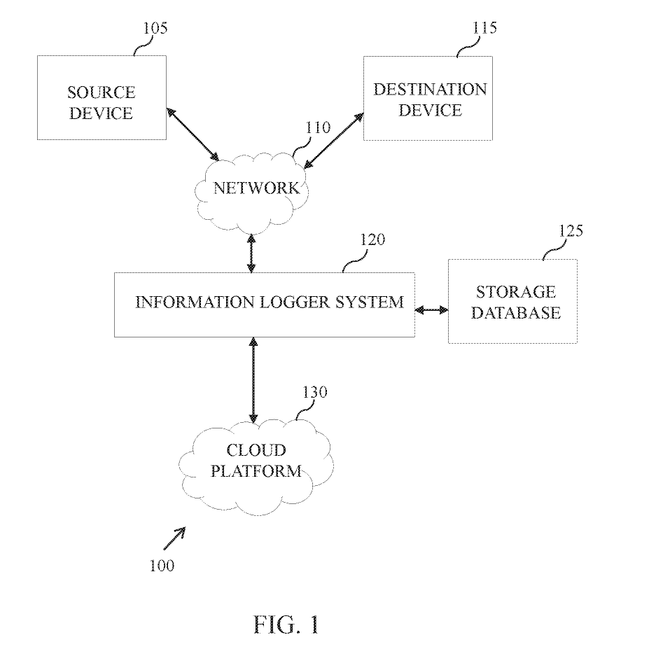

FIG. 1 illustrates a block diagram of an environment 100, in accordance with an embodiment. The environment 100 includes a source device 105, a network 110, a destination device 115, an information logger system 120, a storage database 125, and a cloud platform 130. The present disclosure is explained with respect to a single source device, for example the source device 105, and a single destination device, for example the destination device 115. However, it should be noted that the present disclosure can be similarly applied to multiple source devices and destination devices.

The source device 105 communicates with the information logger system 120 through the network 110. The information logger system 120 communicates with the destination device 115 through the network 110. Examples of the source device 105, the information logger system 120, and the destination device 115 include, but are not limited to, mobile phones, computers, tablets, laptops, palmtops, handheld devices, telecommunication devices, personal digital assistants (PDAs), and the like. Examples of the network 110 include, but are not limited to, a Local Area Network (LAN), a Wireless Local Area Network (WLAN), a Wide Area Network (WAN), internet, a Small Area Network (SAN), and the like.

The information logger system 120 also communicates with the storage database 125 and the cloud platform 130. The storage database 125 can be stored in a server having a local memory, or on cloud. In some embodiments, the storage database 125 is included within the information logger system 120. The storage database 125 is configured to store the information transferred between the source device 105 and the destination device 115 along with relevant details related to the information. The information logger system 120 can be implemented in hardware, software or a combination of both.

The information logger system 120 receives information from the source device 105. The information is being routed from the source device 105 to the destination device 115 through the information logger system 120. The information includes control information and meaningful information. The information logger system 120 detects an information type of the information. The information logger system 120 captures the meaningful information from the information based on the information type. The information logger system 120 stores the meaningful information in a predetermined format. The information logger system 120 further forwards the information to the destination device 115. The meaningful information can be stored, for example in the storage database 125 or in the cloud platform 130.

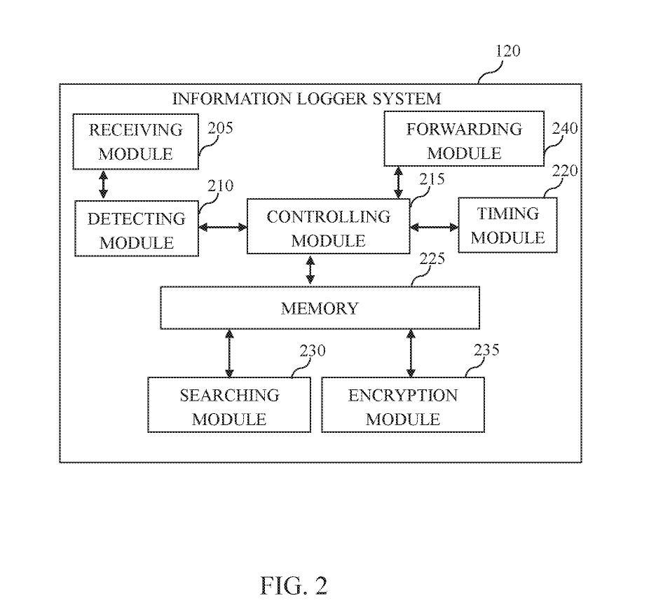

An example embodiment of the information logger system 120 is explained with reference to FIG. 2.

Referring now to FIG. 2, a block diagram of the information logger system 120 in accordance with an embodiment of the invention is illustrated. The information logger system 120 includes a receiving module 205, a detecting module 210, a controlling module 215, a timing module 220, a memory 225, a searching module 230, an encryption module 235, and a forwarding module 240.

The receiving module 205 is configured to receive information from one or more source devices, for example the source device 105 of FIG. 1. The information includes control information and meaningful information. The information is to be routed to the destination device 115. Examples of the source device 105 and the destination device 115 can include, but is not limited to, a mobile device, a smartphone, a computer system, a storage device, a cloud application, a software application, and the like. The source devices can form part of a same network or a different network. Examples of the information can include, but is not limited to, text files generated by a text processing program, email messages, instant messaging communications, personal digital photos, multimedia messages, short message service (SMS) messages, audio and video files, address data or any database files, and the like.

The detecting module 210 in the information logger system 120 is coupled to the receiving module 205 and is configured to detect information type of the information. For example, the detecting module 210 is capable of distinguishing between a text file and a multimedia message. The detecting module 210 is further configured to monitor and identify details of the information from the source device 105.

The controlling module 215 is further coupled to the detecting module 210 and is provided with functionality to distinguish between the meaningful information and the control information present in the information. The detecting module 210 and the controlling module 215 can include one or more processors, microprocessors, and the like. In an embodiment, the detecting module 210 in operational interconnection with the controlling module 215 can be configured to passively monitor transfer or exchange of the information between one or more devices. The detecting module 210 in operational interconnection with the controlling module 215 can further be configured to track other relevant details. Examples of the relevant details include, but are not limited to, time and date of information transfer, time and date of information creation, details of the source device 105, details of the destination device 115, audit information, time and date of creation of the information, time and date of last modification of the information, and the like.

The timing module 220 in the information logger system 120 is coupled to the controlling module 215 and is configured to monitor and log aforesaid time and date related information. In an embodiment, the detecting module 210, the controlling module 215, and the timing module 220 can together be a standalone module.

The memory 225 in the information logger system 120 is coupled to the controlling module 215 and is capable of storing details and the information captured by the detecting module 210, the controlling module 215, and the timing module 220. The details and the information are stored in a predetermined format as per user requirements. For instance, the details can be stored based on the time and date of information transfer, type of content in the information, or type and nature of the source device 105 and the destination device 115, and the like.

In some embodiments, the details and the information captured by the detecting module 210, the controlling module 215, and the timing module 220 can be stored on a cloud platform, for example the cloud platform 130 of FIG. 1. The information and the details that are stored can be used for retrieval or processing at a later point in time.

The searching module 230 is coupled to the memory 225. The searching module 230 is provided with functionality to search the storage database 125 including the stored details and information based on an input received from an administrator or user. Such inputs can include a voice command, a command to search based on a regular pattern, a command for searching based on the time and date of information transfer, the type of content in the information, or the type and nature of the source device 105 and the destination device 115, and the like. The searching module 230 can include one or more processors configured with one or more searching algorithms. The encryption module 235 is coupled to the memory 225 and enables storing of the details relating to the information in the memory 225 in an encrypted form for security reasons. The forwarding module 240 in the information logger system 120 is coupled to the controlling module 215 and is configured to forward the information to the destination device 115.

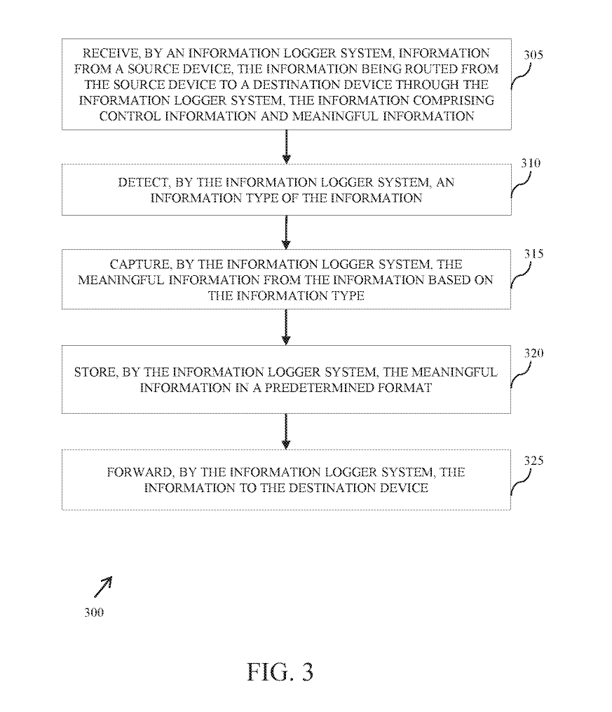

An example method for tracking information transfer between devices is explained with reference to FIG. 3.

FIG. 3 illustrates an example flow diagram of a method 300 for tracking information transfer between devices, in accordance with an embodiment. At step 305, the method 300 includes receiving information from a source device, for example the source device 105 of FIG. 1. The information is received by a receiving module in an information logger system, for example the receiving module 205 of FIG. 2 in the information logger system 120. The information is being routed from the source device to a destination device, for example the destination device 115 of FIG. 1, through the information logger system. The information includes control information and meaningful information. The method of receiving the information by the receiving module is already explained with reference to FIG. 2 and hence is not explained herein for sake of brevity.

At step 310, the method 300 includes detecting an information type of the information. The information type of the information is detected by a detecting module, for example the detecting module 210 of FIG. 2, in the information logger system. The method of detecting the information type of the information by the detecting module is already explained with reference to FIG. 2 and hence is not explained herein for sake of brevity.

At step 315, the method 300 includes capturing the meaningful information from the information based on the information type. The meaningful information is captured from the information by a controlling module, for example the controlling module 215 of FIG. 2, in the information logger system. The method of capturing the meaningful information by the controlling module is already explained with reference to FIG. 2 and hence is not explained herein for sake of brevity.

At step 320, the method 300 includes storing the meaningful information in a predetermined format. The information is stored by a memory, for example the memory 225 of FIG. 2, in the information logger system. The method of storing the information by the memory is already explained with reference to FIG. 2 and hence is not explained herein for sake of brevity.

At step 325, the method 300 includes forwarding the information to the destination device. The information is forwarded by a forwarding module, for example the forwarding module 240 of FIG. 2, in the information logger system.

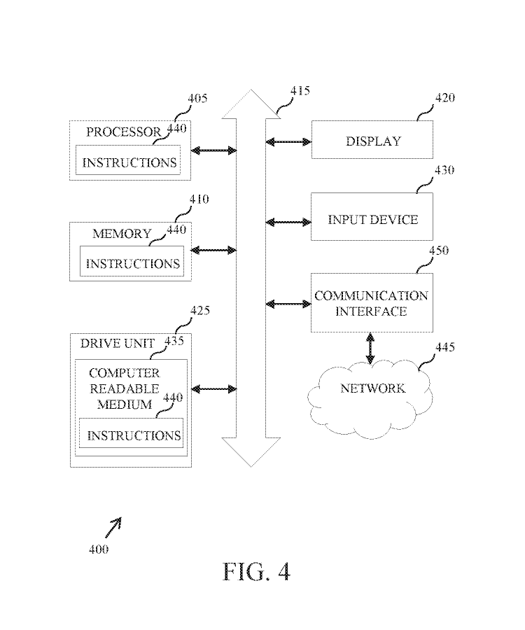

Referring to FIG. 4, illustrates a block diagram of an electronic device 400, which is representative of a hardware environment for practicing the present invention. The electronic device 400 can include a set of instructions that can be executed to cause the electronic device 400 to perform any one or more of the methods disclosed. The electronic device 400 can operate as a standalone device or can be connected, for example using a network, to other electronic devices or peripheral devices.

In a networked deployment of the present invention, the electronic device 400 may operate in the capacity of a source device, for example the source device 105 of FIG. 1, a destination device, for example the destination device 115 of FIG. 1, an information logger system, for example the information logger system 120 of FIG. 1, in a server-client user network environment, or as a peer electronic device in a peer-to-peer (or distributed) network environment. The electronic device 400 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 400 is illustrated, the term “device” shall also be taken to include any collection of systems or sub-systems that individually or jointly execute a set, or multiple sets, of instructions to perform one or more computer functions.

The electronic device 400 can include a processor 405, for example a central processing unit (CPU), a graphics processing unit (GPU), or both. The processor 405 can be a component in a variety of systems. For example, the processor 405 can be part of a standard personal computer or a workstation. The processor 405 can be one or more general processors, digital signal processors, application specific integrated circuits, field programmable gate arrays, servers, networks, digital circuits, analog circuits, combinations thereof, or other now known or later developed devices for analyzing and processing data. The processor 405 can implement a software program, such as code generated manually (for example, programmed).

The electronic device 400 can include a memory 410, such as a memory 410 that can communicate via a bus 415. The memory 410 can include a main memory, a static memory, or a dynamic memory. The memory 410 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 410 includes a cache or random access memory for the processor 405. In alternative examples, the memory 410 is separate from the processor 405, such as a cache memory of a processor, the system memory, or other memory. The memory 410 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 410 is operable to store instructions executable by the processor 405. The functions, acts or tasks illustrated in the figures or described can be performed by the programmed processor 405 executing the instructions stored in the memory 410. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 400 can further include a display unit 420, for example a liquid crystal display (LCD), an organic light emitting diode (OLED), a flat panel display, a solid state display, a cathode ray tube (CRT), a projector, a printer or other now known or later developed display device for outputting determined information. The display 420 can act as an interface for a user to see the functioning of the processor 405, or specifically as an interface with the software stored in the memory 410 or in a drive unit 425.

Additionally, the electronic device 400 can include an input device 430 configured to allow the user to interact with any of the components of the electronic device 400. The input device 430 can include a stylus, a number pad, a keyboard, or a cursor control device, for example a mouse, or a joystick, touch screen display, remote control or any other device operative to interact with the electronic device 400.

The electronic device 400 can also include the drive unit 425. The drive unit 425 can include a computer-readable medium 435 in which one or more sets of instructions 440, for example software, can be embedded. Further, the instructions 440 can embody one or more of the methods or logic as described. In a particular example, the instructions 440 can reside completely, or at least partially, within the memory 410 or within the processor 405 during execution by the electronic device 400. The memory 410 and the processor 405 can also include computer-readable media as discussed above.

The present invention contemplates a computer-readable medium that includes instructions 440 or receives and executes the instructions 440 responsive to a propagated signal so that a device connected to a network 445 can communicate voice, video, audio, images or any other data over the network 445. Further, the instructions 440 can be transmitted or received over the network 445 via a communication port or communication interface 450 or using the bus 415. The communication interface 450 can be a part of the processor 405 or can be a separate component. The communication interface 450 can he created in software or can be a physical connection in hardware. The communication interface 450 can be configured to connect with the network 445, external media, the display 420, or any other components in the electronic device 400 or combinations thereof. The connection with the network 445 can be a physical connection, such as a wired Ethernet connection or can be established wirelessly as discussed later. Likewise, the additional connections with other components of the electronic device 400 can be physical connections or can be established wirelessly. The network 445 can alternatively he directly connected to the bus 415.

The network 445 can include wired networks, wireless networks. Ethernet AVB networks, or combinations thereof. The wireless network can include a cellular telephone network, an 802,11, 802.16, 802.20, 802.1Q or WiMax network. Further, the network 445 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 400.

One or more examples described can implement functions using two or more specific interconnected hardware modules or devices with related control and data signals that can be communicated between and through modules, or as portions of an application-specific integrated circuit. Accordingly, the present system encompasses software, fimiware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

Various embodiments disclosed herein provide numerous advantages by providing a method and system for tracking information transfer between devices. The present disclosure tracks and monitors the information transferred from one device to another. The present disclosure can be implemented without substantial changes in existing information handling systems and without unreasonable additional expenditure.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim

1. A method of tracking information transfer between devices, the method comprising:
receiving, by an information logger system, information from a source device, the information being routed from the source device to a destination device through the information logger system, the information comprising control information and meaningful information;
detecting, by the information logger system, an information type of the information;
capturing, by the information logger system, the meaningful information from the information based on the information type;
storing, by the information logger system, the meaningful information in a predetermined format; and
forwarding, by the information logger system, the information to the destination device.

2. The method as claimed in claim 1 and further comprising:
tracking, by the information logger system, one or more relevant details of the information,

3. The method as claimed in claim 2 and further comprising:
monitoring, by the information logger system, time and date related information associated with the information, wherein the time and date related information is further logged.

4. The method as claimed in claim 3 and further comprising:
searching, by the information logger system, the meaningful information along with the one or more relevant details stored in the predetermined format.

5. The method as claimed in claim 4 and further comprising:
encrypting, by the information logger system, the meaningful information along with the one or more relevant details for storage.

6. An information logger system for tracking information transfer between devices, the information logger system comprising:
a receiving module configured to receive information from a source device, the information being routed from the source device to a destination device through the information logger system, the information comprising control information and meaningful information;
a detecting module configured to detect an information type of the information;
a controlling module configured to capture the meaningful information from the information based on the information type;
a memory configured to store the meaningful information in a predetermined format; and
a forwarding module configured to forward the information to the destination device.

7. The information logger system as claimed in claim 6, wherein the controlling module is further configured to track one or more relevant details of the information.

8. The information logger system as claimed in claim 7 and further comprising:
a timing module configured to monitor and log time and date related information associated with the information.

9. The information logger system as claimed in claim 8 and further comprising:
a searching module configured to search the meaningful information along with the one or more relevant details stored in the memory.

10. The information logger system as claimed in claim 9 and further comprising:
an encryption module configured to encrypt the meaningful information along with the one or more relevant details for storage in the memory.
